(19) United States
(12) Patent Application Publication
(10) Pub. No.: US 2007/0103631 A1
(43) Pub. Date: May 10, 2007

(54) Thin film transistor panel for liquid crystal display and liquid crystal display comprising the same

(76) Inventors: Hong Man Moon, Gumi-si (KR); Hyun Cheol Jin, Gumi-si (KR)

Correspondence Address: MCKENNA LONG & ALDRIDGE LLP, 1900 K STREET, NW, WASHINGTON, DC, 20006, US

(21) Appl. No.: 11/449,788

(22) Filed: Jun. 9, 2006

(30) Foreign Application Priority Data
Nov. 9, 2005 (KR) 10-2005-0107231

(51) Int. Cl. G02F 1/1343

(52) U.S. Cl. 349/139

(57) ABSTRACT

A thin film transistor substrate for a liquid crystal display, which can provide a required pixel discharging time, and a liquid crystal display comprising the same are disclosed. The thin film transistor substrate comprises a plurality of unit pixels arranged in an (m×n) matrix array, gate lines disposed one by one for every two unit pixels neighboring in a column direction, wherein one gate signal is simultaneously supplied to the two unit pixels via one gate line, data lines intersecting the gate lines, supplying data signals to the unit pixels in synchronization with the gate signals supplied via the gate lines wherein said data lines are arranged two by two between the unit pixels neighboring in a row direction and a thin film transistor TFT formed at each crossing portion of the gate lines and the data lines and transmitting the data signals to pixel electrodes in response to the gate signals.

This application claims the benefit of Korean Patent Application No. 10-2005-0107231, filed on Nov. 9, 2005, which is hereby incorporated by reference for all purposes as if fully set forth herein.

### BACKGROUND OF THE INVENTION

1. Field of the Invention

The present invention relates to a liquid crystal display, and more particularly, to a thin film transistor substrate for a high resolution liquid crystal display, which can provide a required pixel charging time, and a liquid crystal display comprising the same.

2. Discussion of the Related Art

FIG. 1 is a block diagram of a liquid crystal display according to a related art.

As shown in FIG. 1, the liquid crystal display according to the related art comprises a display area 10, a gate driver 20, a source driver 30 and a timing controller (T-CON) 40.

A plurality of gate lines (S₁, . . . Sn) and data lines (D₁, . . . Dm) are formed in a matrix within the display area 10. Also, a thin film transistor (TFT) is formed at an intersection of the gate lines and the data lines.

A common electrode and a color filter may be formed on an opposite substrate opposing the substrate on which the thin film transistor (TFT) is formed, and liquid crystal is injected between the two substrates to form a complete liquid crystal panel.

Although not shown in detail, the thin film transistor TFT may comprise a gate electrode, a source electrode, a drain electrode, an active layer, an ohmic contact layer, and other elements and the drain electrode may be connected to a pixel electrode to form a unit pixel P. When a gate signal is applied to the gate electrode via the gate lines, a data signal applied to the data lines is transmitted from the source electrode to the drain electrode through the ohmic contact layer and the active layer, thereby driving the thin film transistor having such a structure.

When a data signal is applied to the source electrode, a corresponding voltage is applied to the pixel electrode connected to the source electrode, which causes a voltage difference between the pixel electrode and the common electrode. The liquid crystal molecules interposed between the respective electrodes change their arrangement according to the voltage difference between the pixel electrode and the common electrode, and thus the amount of pixel light transmission is changed due to the change of the arrangement of the liquid crystal molecules. Hence, the color of the pixel changes according to a difference between the data signals applied to each pixel. The display screen of the liquid crystal display can be controlled by using such a color difference.

The data signals applied to the source electrode are supplied from the source driver 30, and the gate signals applied to the gate electrode are supplied from the gate driver 20 as shown in FIG. 1.

The gate driver 20 sequentially provides gate signals for activating or deactivating the gate electrode to the gate lines, respectively. Then, the source driver 30 provides gray-level voltages corresponding to the data signals to the plurality of data lines according to a determined timing when the gate signals are applied. Synchronization between the source driver 30 and the gate driver 20 is performed by the timing controller (T-CON) 40.

FIG. 2 is a view showing a layout of the thin film transistor substrate according to the related art.

Referring to FIG. 2, the thin film transistor substrate according to the related art comprises a unit pixel (11), gate lines 12-1 and 12-2, and data lines 13-1, 13-2. A thin film transistor is formed at a crossing portion of the gate lines 12-1 and 12-2 and the data lines 13-1, 13-2.

In order to increase the resolution of the liquid crystal display, the number of pixels should be increased. Increasing the number of pixels results in an increase of the number of gate lines. However, when the number of gate lines increases, the gate-on time decreases, which leads to a reduction of the charging time of each pixel. Hence, the probability of charge shortage is increased.

In other words, when the driving frequency and the number of gate lines are increased to create a high resolution image, the gate-on time allocated to each gate line is sharply reduced. As a result, there may occur problems such as poor picture quality due to the shortage of the charging time of each pixel.

### SUMMARY OF THE INVENTION

Accordingly, the present invention is directed to a thin film transistor panel for a liquid crystal display and liquid crystal display comprising the same, which can increase the charging time of pixels by ensuring an appropriate gate-on time.

An advantage of the present invention includes a reduction in the probability of a charge shortage.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, there is provided a thin film transistor substrate for a liquid crystal display panel in accordance with an embodiment of the present invention, comprising: a plurality of unit pixels arranged in an (m×n) matrix array; gate lines disposed one by one for every two unit pixels neighboring in a column direction, wherein one gate signal is simultaneously supplied to the two unit pixels via one gate line; data lines intersecting the gate lines, supplying data signals to the unit pixels in synchronization with the gate signals supplied via the gate lines wherein the data lines are arranged two by two between the unit pixels neighboring in a row direction; and a thin film transistor TFT formed at each crossing portion of the gate lines and the data lines and transmitting the data signals to pixel electrodes in response to the gate signals.

When the number of unit pixels in the column direction is n, the number of gate lines may be n/2.

When the number of unit pixels in the row direction is m, the number of data lines may be 2m.

Each of the data lines may be arranged one by one at both sides of unit pixels in the row direction.

When the number of unit pixels in the row direction is m, a 2m number of thin film transistors may be formed on the gate lines.

The gate lines sequentially supply gate signals to the entire gate lines.

In another aspect of the invention, there is provided a liquid crystal display which comprises: a source driver for applying a data signal to data lines; a gate driver for applying a gate signal to gate lines; and a liquid crystal panel for displaying data through unit pixels in response to the gate signal and the data signal, the liquid crystal panel comprising: a plurality of unit pixels arranged in an (m×n) matrix array; gate lines disposed one by one for every two unit pixels neighboring in a column direction and simultaneously supplying gate signals; data lines intersecting the gate lines, supplying data signals to the unit pixels in synchronization with the gate signals supplied via the gate lines wherein the data lines are arranged two by two between the unit pixels neighboring in a row direction; and a thin film transistor TFT formed at each crossing portion of the gate lines and the data lines and transmitting the data signals to pixel electrodes in response to the gate signals.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a liquid crystal display according to a related art;

FIG. 2 is a view showing a layout of the thin film transistor substrate according to the related art;

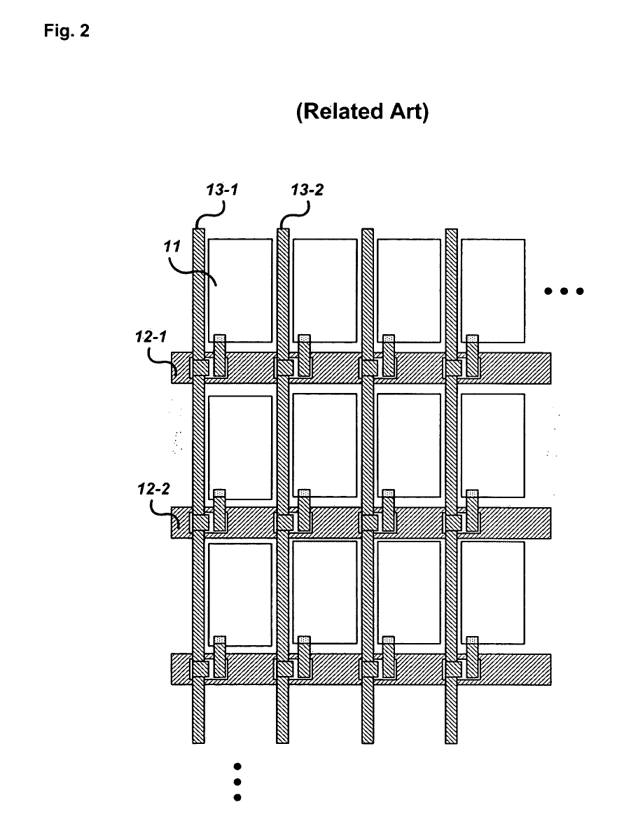

FIG. 3 is a block diagram of a liquid crystal display in accordance with an embodiment of the present invention;

FIG. 4 is a view showing a layout of a thin film transistor substrate in accordance with an embodiment of the present invention;

FIG. 5 is an exploded perspective view showing a liquid crystal display comprising a thin film transistor substrate in accordance with an embodiment of the present invention.

### DETAILED DESCRIPTION OF THE ILLUSTRATED EMBODIMENTS

Reference will now be made in detail to an embodiment of the present invention, example of which is illustrated in the accompanying drawings. Like reference numerals designate like elements throughout the detailed description.

An embodiment of the present invention will now be described in detail with reference to the accompanying drawings.

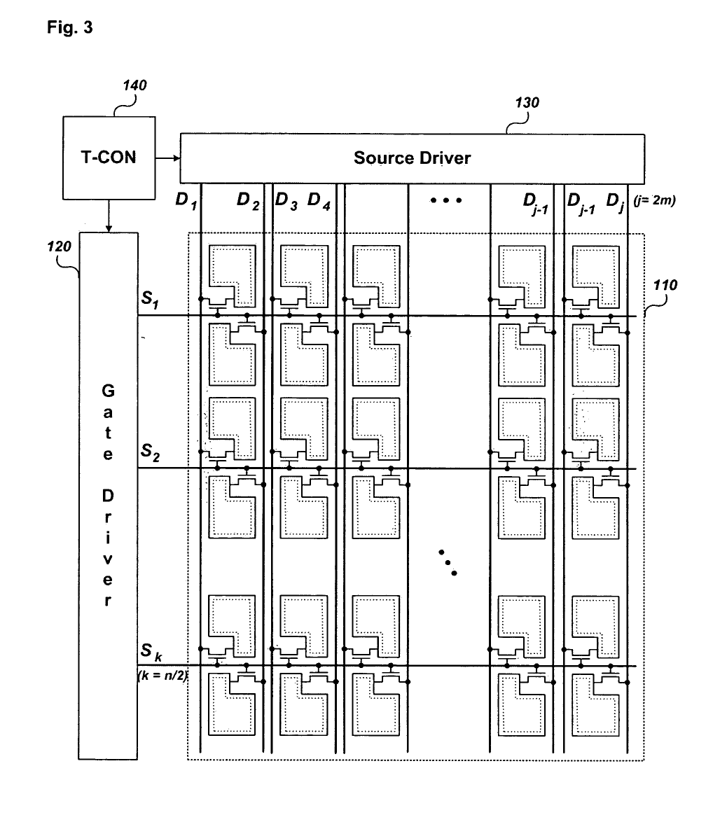

FIG. 3 is a block diagram of a liquid crystal display in accordance with an embodiment of the present invention.

Referring to FIG. 3, the liquid crystal display in accordance with the embodiment of the present invention comprises a display area 110, a gate driver 120, a source driver 130 and a timing controller 140.

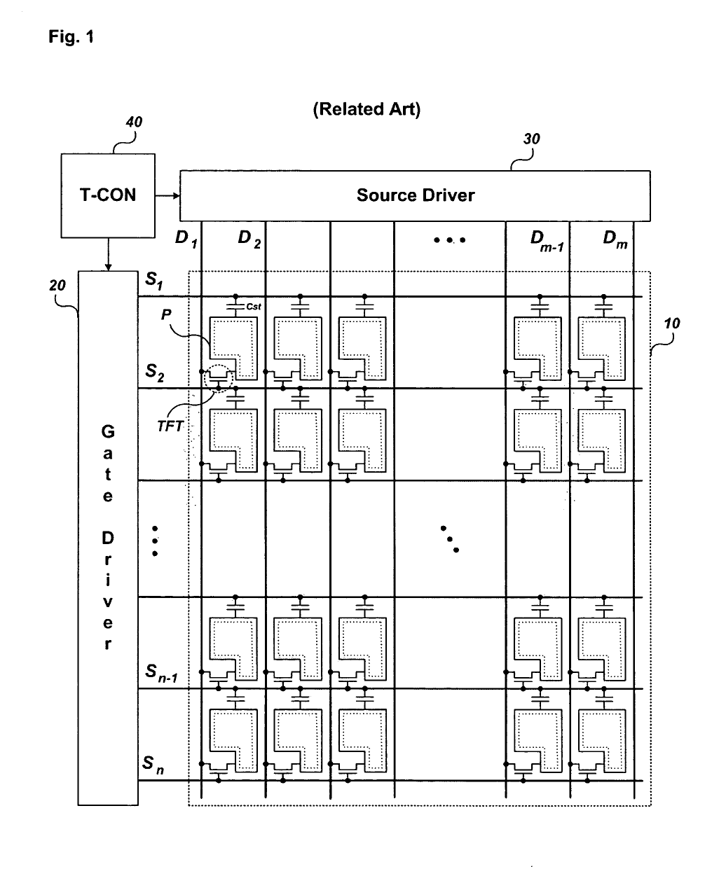

A plurality of gate lines (S₁, . . . Sₖ) and data lines (D₁, . . . Dⱼ) are formed in a matrix within the display area 110. As shown in FIG. 3, data lines are arranged between unit pixels in a vertical direction, while one gate line is arranged between two unit pixels in a horizontal direction. When comparing FIG. 3 with FIG. 1, it can be seen that a k-number of gate lines corresponding to a (n/2)-number thereof and a j-number of data lines corresponding to a 2m-number thereof are arranged. At a crossing portion of the plurality of gate lines and data lines, a thin film transistor (TFT) is formed. The position where the transistor is formed in the column direction of the unit pixels may be modified, and hence the layout structure of a thin film transistor substrate may be modified. That is, the position of each unit pixel connected to the thin film transistor may be modified accordingly.

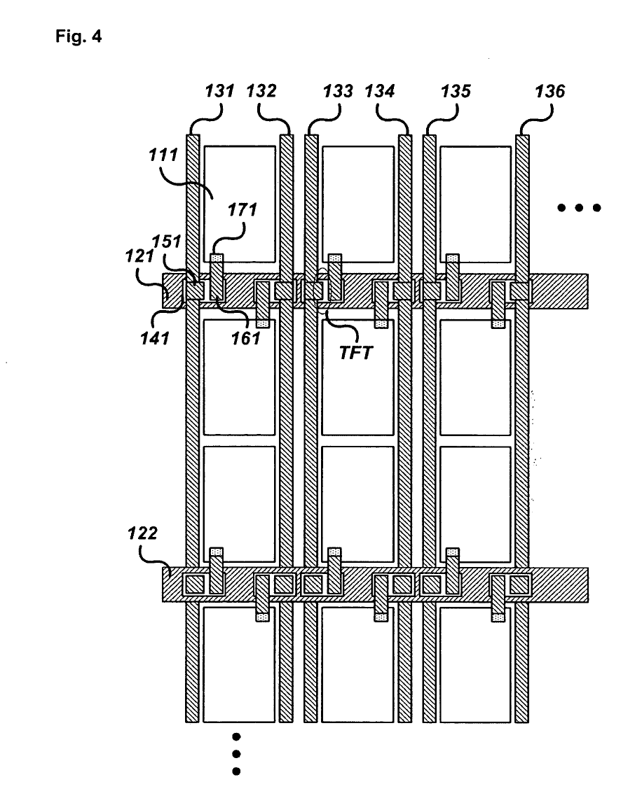

FIG. 4 is a view showing a layout of a thin film transistor substrate in accordance with an embodiment of the present invention.

As shown in FIG. 4, the thin film transistor substrate in accordance with an embodiment of the present invention comprises unit pixels 111, gate lines 121 and 122, data lines 131, 132, . . . , 136) and thin film transistors TFTs.

The unit pixels 111 have a two-dimensional array pattern of (j×k) type, and may be made of a material such as ITO (indium tin oxide).

The gate lines 121 and 122 sequentially supply a gate signal to every two lines neighboring in the column direction of the unit pixels 111. The first gate line 121, for example, is formed between the first row of unit pixels and the second row of unit pixels to simultaneously apply sequentially applied gate signals to the unit pixels of the first row and the unit pixels of the second row. The last gate line may be formed between the unit pixels of the (k−1)th row and the unit pixels of the k-th row to sequentially apply gate signals.

Therefore, a gate-on time greater than twice that of the liquid crystal display according to the related art is ensured, providing more stable charging of pixels.

The data lines 131, 132, . . . , 136 are formed to cross the gate lines 121 and 122, and the data signal synchronized with the gate signal supplied via the gate lines 121 and 122, thus supplying synchronized signals to the unit pixels 111.

The two lines of unit pixels neighboring in the row direction are simultaneously gated-on, and thus two lines of data signals can be supplied to the unit pixels as well.

The thin film transistor (TFT) is formed at a crossing of the gate lines 121 and 122 and the data lines 131, 132, . . . , 136, and switches the transmission of the data signals to pixel electrodes in response to the gate signals. Therefore, the thin film transistor (TFT) serving as a switching element must be provided respectively for each unit pixel 111. For this, the data lines 131, 132, . . . , 136 are arranged two by two between the unit pixels 111 neighboring in the column direction.

Two data lines may be formed between the first column of unit pixels and the second column of unit pixels, and in the same way as above, two data lines may be formed between the (j−1)-th column of unit pixels and the j-th column of unit pixels. Here, as shown in the drawing, one data line can be additionally formed prior to the first column of unit pixels and next to the j-th column of unit pixels, respectively. Further, in a situation where two data lines are initially formed between the first column of unit pixels and the second column of unit pixels, two data lines can be formed next to the j-th column of unit pixels.

If the number of unit pixels in the column direction is an odd number, that is, the number of gate lines, i.e., k is an odd number, one gate line may be connected to the first or last column of unit pixels.

Although not shown, the present invention also applies to the gate driver divided into two and capable of driving odd/even gate lines, respectively.

Reference numeral 151 denotes a source portion of a thin film transistor extending in a substantially horizontal direction in a data line, reference numeral 161 denotes a drain, and reference numeral 171 denotes a drain connecting portion connected to the unit pixels 111. Reference numeral 141 denotes part of an insulating film for insulating gate lines and data lines.

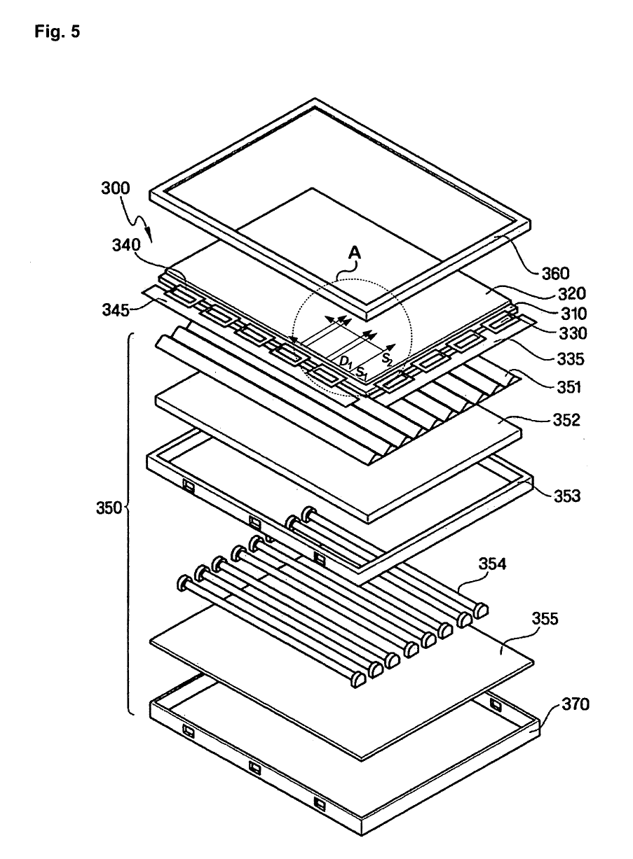

FIG. 5 is an exploded perspective view showing a liquid crystal display comprising a thin film transistor substrate in accordance with an embodiment of the present invention.

Referring to FIG. 5, the liquid crystal display according to the embodiment of the present invention comprises a liquid crystal display panel 300, a backlight unit 350 and a top chassis 360.

The liquid crystal display panel 300 comprises a lower substrate 310, an upper substrate 320, a liquid crystal (not shown), a gate tape carrier package (TCP) 330, a gate printed circuit board (PCB) 335, a data TCP 340 and a data PCB 345.

The lower substrate 310 comprises gate lines, data lines, thin film transistors and pixel electrodes and the upper substrate 320 is located on the top of the lower substrate 310 to be opposite therefrom and, though not shown, may comprise a common electrode and a color filter.

In the art that in an IPS mode, the common electrode may be formed on the lower substrate 310.

The gate TCP 330 is connected to each gate line formed on the lower substrate 310, and the data TCP 340 is connected to each data line formed on the lower substrate 310.

Various circuit parts capable of processing both gate driving signals and data driving signals are mounted in the gate PCB 335 and the data PCB 345 so that the gate driving signals can be inputted into the gate TCP 330 and the data driving signals can be inputted into the data TCP 340.

As shown by reference numeral A of FIG. 5, the lower substrate 310 of the liquid crystal display according to an embodiment of the present invention is structured such that a gate signal is supplied to two lines of neighboring unit pixels neighboring in a row direction by one gate line.

Hence, one gate-on function can be performed during typical two gate-on times, thereby ensuring a more stable pixel charging time. As a result, a high resolution model having a high driving frequency provides stable image information.

For more details, reference may be made to the above description of FIG. 4.

The backlight unit 350 comprises an optical sheet 351, a diffusion plate 352, a mold frame 353, a lamp 354, a reflecting plate 355 and other elements.

The lamp 354 irradiates light and the reflecting plate 355 is installed at a lower part of the lamp 354 to reflect the light emitted to the lower part of the lamp 354 in the direction of the diffusion plate 352 on the top of the reflecting plate 355.

The light irradiated from the lamp 354 and the light reflected by the reflecting plate 355 are diffused to have the same luminance, and then collected by the optical sheet 351 which may be a prism or equivalent.

The above-explained components of the backlight unit 350 are housed in an internal space defined by the mold frame 353 and a bottom chassis 370 coupling to each other, and the bottom chassis 370 is coupled to the top chassis 360 to form the entire frame of the liquid crystal display.

Although the liquid crystal display described by the embodiment of FIG. 5 has been illustrated with respect to a direct type backlight unit 350 it is needless to say that the backlight unit 350 of the liquid crystal display of the present invention may be of various types, including a direct type, an edge type, a wedge type, or other variations.

Because the time for charging the unit pixels may be obtained by dividing the driving frequency, for driving the liquid crystal panel by a vertical resolution which is the number of gate lines, if the driving frequency becomes higher for a high resolution, the time for charging the unit pixels becomes shorter. However, according to an embodiment of the present invention, since the number of gate lines is reduced to ½ as compared with the related art, a sufficient charging time can be ensured even if the driving frequency is increased.

According to the thin film transistor substrate for a liquid crystal display and the liquid crystal display comprising the same in accordance with an embodiment of the present invention, a gate-on time approximately twice greater than that of the related art liquid crystal display can be ensured.

Accordingly, it is possible to provide more stable image information since a sufficient pixel charging time is ensured even if the driving frequency of the liquid crystal display is increased due to an increase in resolution.

Moreover, it is possible to obtain a process margin due to a decrease in a number of gate lines since two lines of neighboring unit pixels in a row direction can be driven by one gate line.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A thin film transistor substrate for a liquid crystal display panel, comprising:
a plurality of unit pixels arranged in an (m×n) matrix array;
gate lines disposed one for every two unit pixels neighboring in a column direction, wherein one gate signal is simultaneously supplied to the two unit pixels via one gate line;
data lines intersecting the gate lines and supplying data signals to the unit pixels in synchronization with the gate signals supplied via said gate lines wherein said data lines are arranged two between the unit pixels neighboring in a row direction; and
a thin film transistor TFT formed at each crossing portion of the gate lines and the data lines and transmitting the data signals to pixel electrodes in response to the gate signals.

2. The thin film transistor substrate of claim 1, wherein when the number of unit pixels in the column direction is n, the number of gate lines is n/2.

3. The thin film transistor substrate of claim 1, wherein when the number of unit pixels in the row direction is m, the number of data lines is 2m.

4. The thin film transistor substrate of claim 1, wherein each of the data lines is arranged one by one at both sides of unit pixels in the row direction.

5. The thin film transistor substrate of claim 1, wherein when the number of unit pixels in the row direction is m, a 2m number of thin film transistors are formed on the gate lines.

6. The thin film transistor of claim 1, wherein the gate lines sequentially supply gate signals to the entire gate lines.

7. A liquid crystal display, comprising:
a source driver for applying a data signal to data lines;
a gate driver for applying a gate signal to gate lines; and
a liquid crystal panel for displaying data through unit pixels in response to the gate signal and the data signal,
the liquid crystal panel comprising:
a plurality of unit pixels arranged in an (m×n) matrix array;
gate lines disposed one for every two unit pixels neighboring in a column direction and simultaneously supplying gate signals;
data lines intersecting the gate lines, supplying data signals to the unit pixels in synchronization with the gate signals supplied via said gate lines wherein said data lines are arranged two between the unit pixels neighboring in a row direction; and
a thin film transistor TFT formed at each crossing portion of the gate lines and the data lines and transmitting the data signals to pixel electrodes in response to the gate signals.

8. The liquid crystal display of claim 7, wherein when the number of unit pixels in the column direction is n, the number of gate lines is n/2.

9. The liquid crystal display of claim 7, wherein when the number of unit pixels in the row direction is m, the number of data lines is 2m.

10. The liquid crystal display of claim 7, wherein each of the data lines is arranged one by one at both sides of unit pixels in the row direction.

11. The liquid crystal display of claim 7, wherein when the number of unit pixels in the row direction is m, a 2m number of thin film transistors are formed on the gate lines.

12. The liquid crystal display of claim 6, wherein the gate lines sequentially supply gate signals to the entire gate lines.

13. A method of manufacturing a thin film transistor substrate for a liquid crystal display panel, comprising:
forming a plurality of unit pixels arranged in an (m×n) matrix array;
forming gate lines disposed one for every two unit pixels neighboring in a column direction, wherein one gate signal is simultaneously supplied to the two unit pixels via one gate line;
forming data lines intersecting the gate lines and supplying data signals to the unit pixels in synchronization with the gate signals supplied via said gate lines wherein said data lines are arranged two between the unit pixels neighboring in a row direction; and
forming a thin film transistor TFT formed at each crossing portion of the gate lines and the data lines and transmitting the data signals to pixel electrodes in response to the gate signals.
